(19) United States
(12) Patent Application Publication
(10) Pub. No.: US 2010/0309302 A1
(43) Pub. Date: Dec. 9, 2010

(54) Apparatus and a System for Visualizing Teeth Cleaning

(76) Inventor: Jiandong Yang, Pleasanton, CA (US)

Correspondence Address: Jiandong Yang, 6235 Roslin Ct, Pleasanton, CA, 94588, US

(21) Appl. No.: 12/794,710

(22) Filed: Jun. 4, 2010

Related U.S. Application Data
(60) Provisional application No. 61/185,202, filed on Jun. 9, 2009.

(51) Int. Cl. H04N 7/18

(52) U.S. Cl. 348/77; 348/E07.085

(57) ABSTRACT

A system includes an apparatus having a head having a removable cap having a tool configured for cleaning activities within a mouth. A handle is joined to the head for enabling the head to be manipulated within the mouth. An image sensor having a lens is at least partially disposed on the head for capturing images within the mouth. An illumination source is disposed on the head for illuminating objects to assist the image sensor in capturing the images. A transmitter conveys the images. A receiver receives the conveyed images. A display is connected to the receiver for displaying the conveyed images thereby assisting a user in the cleaning activities.

### CROSS-REFERENCE TO RELATED APPLICATIONS

The present Utility patent application claims priority benefit of the U.S. provisional application for patent Ser. No. 61/185,202 and entitled “Tooth Cleaning System with Image Sensor”, filed on 9 Jun. 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to dental hygiene devices. More particularly, the invention relates to a tooth cleaning system with an image sensor.

### BACKGROUND OF THE INVENTION

The present invention is related to a tooth cleaning system having an image sensor and a display to generally enable users to easily view their own teeth while cleaning their teeth.

Previously, people have had difficulty seeing some portions of their teeth while cleaning their teeth by themselves, for example, without limitation, when using a toothbrush to brush the inner side of the upper teeth. Being able to view the teeth while cleaning them makes cleaning easier and enables users to monitor their teeth daily without extra efforts while they are cleaning their teeth. In some special cases it is especially helpful for users to see locations in the mouth, for example, without limitation, when cleaning gaps in teeth or when cleaning the teeth on either side of a missing tooth.

In view of the foregoing, there is a need for improved techniques for providing means for enabling users to view their teeth while cleaning the teeth.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a front perspective view of an exemplary tooth cleaning system with an image sensor, in accordance with an embodiment of the present invention;

FIGS. 2A and 2B illustrate an exemplary tooth cleaning device with an image sensor, in accordance with an embodiment of the present invention. FIG. 2A is a front perspective view, and FIG. 2B is a cross sectional view;

FIG. 3 is a front perspective view of an exemplary tooth cleaning device with an image sensor and replaceable bristles, in accordance with an embodiment of the present invention;

FIG. 4 is a cross sectional view of an exemplary tooth cleaning device with an image sensor, in accordance with an embodiment of the present invention;

FIG. 5 is a front perspective view of an exemplary tooth cleaning device with an image sensor, in accordance with an embodiment of the present invention;

FIG. 6 is a schematic diagram of an exemplary electronic system for a tooth cleaning system in which an image sensor directly sends image signals to a display unit, in accordance with an embodiment of the present invention;

FIG. 7 is a schematic diagram illustrating an exemplary electronic system for a tooth cleaning system in which an image sensor sends image signals to a display unit wirelessly, in accordance with an embodiment of the present invention;

FIG. 8 is a schematic diagram illustrating an exemplary electronic system for a tooth cleaning system in which an image sensor sends image signals to a microcontroller and the microcontroller sends the image signals to a display unit, in accordance with an embodiment of the present invention; and

FIG. 9 is a schematic diagram illustrating an exemplary electronic system for a tooth cleaning system in which an image sensor sends image signals to a microcontroller and the microcontroller sends the image signals out from a transmitter as wireless signals, in accordance with an embodiment of the present invention.

Unless otherwise indicated illustrations in the figures are not necessarily drawn to scale.

### SUMMARY OF THE INVENTION

To achieve the forgoing and other aspects and in accordance with the purpose of the invention, an apparatus and a system for visualizing teeth cleaning is presented.

In one embodiment an apparatus includes means for cleaning within an oral cavity, means for supporting the cleaning means and for enabling the cleaning means to be manipulated within the oral cavity and means for capturing images within the oral cavity to assist a user in the cleaning. Another embodiment further includes means for illuminating objects to assist the capturing means in capturing the images. Yet another embodiment further includes means for enabling cleaning of an exterior surface of the capturing means. Still another embodiment further includes means for conveying the images to a display. Another embodiment further includes means for enabling one or more functions of the apparatus.

In another embodiment an apparatus includes a head configured for cleaning activities within an oral cavity. A handle supports the head and enables the head to be manipulated within the oral cavity. An image sensor, at least partially disposed on the head, captures images within the oral cavity to assist a user in the cleaning activities. Another embodiment further includes an illumination source for illuminating objects to assist the image sensor in capturing the images. Yet another embodiment further includes a nozzle for enabling cleaning of an exterior surface of the image sensor. Still another embodiment further includes a transmitter for conveying the images to a display. Another embodiment further includes at least one control button for enabling one or more functions of the apparatus. In yet another embodiment the nozzle directs a liquid flow. In still another embodiment the head further comprises a cap having a tool for the cleaning activities. In another embodiment the cap is removable from the remainder of the head. In yet another embodiment the tool comprises one or more brushes. In still another embodiment the transmitter conveys the images wirelessly. In another embodiment the illumination source comprises a LED. In yet another embodiment the exterior surface of the image sensor comprises a lens.

In another embodiment a system includes a head having a removable cap having a tool configured for cleaning activities within a mouth. A handle is joined to the head for enabling the head to be manipulated within the mouth. An image sensor having a lens is at least partially disposed on the head for capturing images within the mouth. An illumination source is disposed on the head for illuminating objects to assist the image sensor in capturing the images. A nozzle is disposed on the head for directing a flow of liquid for cleaning the lens. At least one control button enables one or more functions of the apparatus. A transmitter conveys the images. A receiver receives the conveyed images. A display is connected to the receiver for displaying the conveyed images thereby assisting a user in the cleaning activities. In another embodiment the tool comprises one or more brushes. In yet another embodiment the transmitter conveys the images to the receiver wirelessly.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a tooth cleaning system comprising an image sensor and a display unit to generally enable users to easily view their own teeth while cleaning their teeth. In preferred embodiments, the image sensor is located near a cleaning means tool of the tooth cleaning system for example, without limitation, a toothbrush, dental pick, flossing device, etc. In preferred embodiments the display unit is separate from a supporting means for the cleaning means tool and may connect to the supporting means through a cable or wirelessly. Some embodiments of the present invention may comprise added elements such as, but not limited to, light sources, water sprayers, control buttons, timers, etc. However, a basic embodiment of the present invention comprises cleaning means tool and supporting means with only an image sensor.

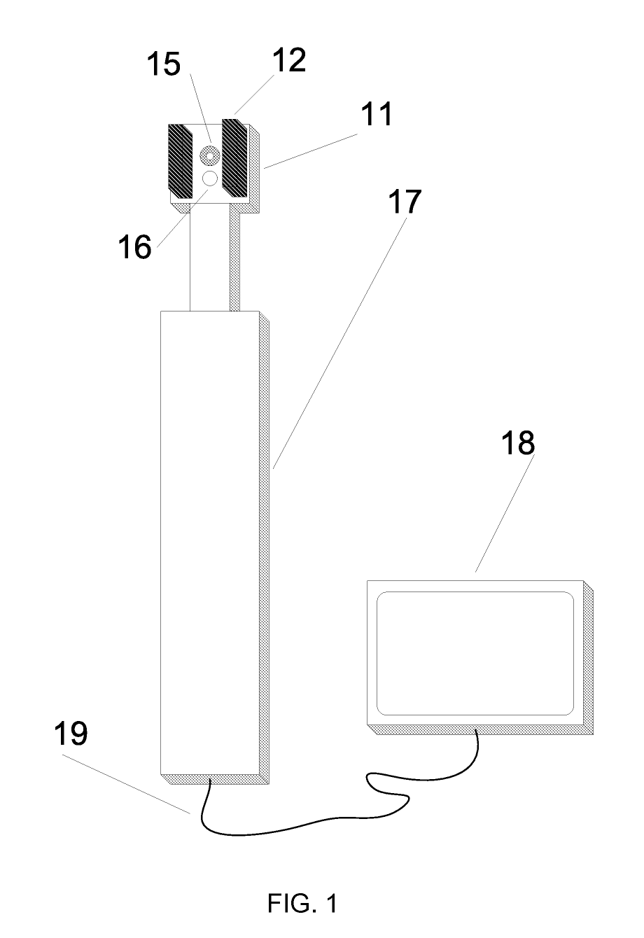

FIG. 1 is a front perspective view of an exemplary tooth cleaning system with an image sensor 15, in accordance with an embodiment of the present invention. In the present embodiment, a toothbrush is used as the cleaning means; however, various different types of cleaning means may be used in alternate embodiments such as, but not limited to, pointed dental tools, water-spraying devices, dental scrapers, flossing devices, tongue scrapers, etc. In the present embodiment, a handle 17 supports the cleaning means and enables a user to hold and operate the toothbrush, and some electronic circuitry can be mounted inside handle 17. In alternate embodiments, the electronic circuitry may be outside of the handle. For example, without limitation, the circuitry may be incased in a waterproof cord or mounted to the outside surface of the handle. In the present embodiment, a head 11 of the toothbrush comprises bristles 12, which act as tooth cleaning members. Bristles 12 can be manually moved or driven by electrical power. Image sensor 15 is also mounted on head 11 near bristles 12. In the present embodiment, image sensor 15 is mounted to a tooth cleaning device; however, in alternate embodiments, a tooth cleaning device may be mounted to an image sensor. In some implementations, handle 17 and head 11 can be two portions of a single object, for example, a single molded elongated part.

In the present embodiment, image sensor 15 is a device that converts an optical image into an electric signal. Complementary metal-oxide-semiconductor (CMOS) and charge-coupled device (CCD) sensors are typical types of image sensors; however, different types of image sensors may be used. For example, without limitation, image sensor 15 can be a device which can sense signals and in combination with other means such as, but not limited to, electronic circuitry and signal processing software can use these signals to create images. Examples of this type of sensor include, without limitation, an ultrasound transducer. Usually, there is a lens in front of image sensor 15 to adjust the viewing area. Therefore, when image sensor 15 is mentioned herein in accordance with the present embodiment, a lens is included by default; however, some embodiments may be incorporated without a lens. In alternate embodiments the location of the lens and the image sensor may vary. For example, without limitation, the image sensor may be located on the top of the head or may be above or below the bristles rather than in between the bristles. Other alternate embodiments may comprise optical components that can pass light and image so that the image sensor on the cleaning device may only be an image collection window and the actual image sensor may be placed in other possible locations not immediately behind the lens such as, but not limited to, in the handle, in a display unit, outside the cleaning device, etc. The lens can be directly as part of the surface of head 11 or image sensor is behind a transparent layer of head 11. In both cases, the surface is preferred to be hydrophobic. A light source 16 is used in the present embodiment as an illumination means to provide enough light on the object being viewed to assist image sensor 15 in capturing the image. Various different types of light sources may be used such as, but not limited to, an LED, a light bulb, etc. In some alternate embodiments, no light source may be included.

In the present embodiment, a display unit 18 is used to show the image obtained by image sensor 15. Display unit 18 may be held by hand or may be placed on a wall or flat surface. The image information can be transferred to display unit 18 as analog signals, such as, but not limited to, composite video, or as digital data. A typical digital image format includes 8-bit data and vertical and horizontal synchronization signals. However, various different image formats may be used. In some embodiments, the image shown on display unit 18 can be zoomed in and out by using optical or digital methods. Other embodiments may not incorporate a zoom function. In the present embodiment, a conveying means, cable 19, transfers signals between image sensor 15 and display unit 18. However, in alternate embodiments, the communication between the image sensor and the display unit can be a wireless conveying means. Currently, there are many protocols and standards available to transmit images or video without wires, for example, without limitation, television (TV), Wi-Fi, as well as some proprietary protocols. Radio frequency (RF) or optical signals may also be used to transfer video and images.

The power source for the system according to the present embodiment is not shown as it may be any power source that is typical for an electronic system such as, but not limited to, batteries installed inside the system or an external power supply plugged into the system. For example, without limitation, a battery can be placed in handle 17 or in display unit 18, or an external power supply plug can be included on handle 17 or display unit 18. Some embodiments may use both batteries and an external power supply. For example, without limitation, batteries may be included in the handle to power the cleaning device while an external power supply powers the display unit. In the present embodiment, the preferred power supply configuration comprises a battery or plug on the side of display unit 18, and cable 19 includes a power wire to transfer power to handle 17.

In typical use of the present embodiment, a user holds handle 17 and inserts brush head 11 into his mouth. While bristles 12 clean his teeth, image sensor 15 is turned on, collects image information and transmits this information to display unit 18. While bristles 12 are moving and cleaning the teeth, either manually or electrically, the user can see an image of the area under brush head 11 on display unit 18 so that the user may adjust their cleaning action according to what they see on display unit 18. In the present embodiment, the image information is displayed as a real time video. However, in alternate embodiments, the image may be displayed as still images that are updated at a predetermined interval, for example, without limitation, every five seconds, or by manual control. Using the present embodiment, the user can watch while brushing or watch then brush. When bristles 12 are electrically driven so that bristles 12 alone move, head 11 as well as image sensor 15 remain relatively steady. This makes it is possible for the user to watch the teeth while they are being cleaned. When head 11 and bristles 12 are moved together, image sensor 15 also moves, and the user may use the pattern of brush then watch to use the cleaning device.

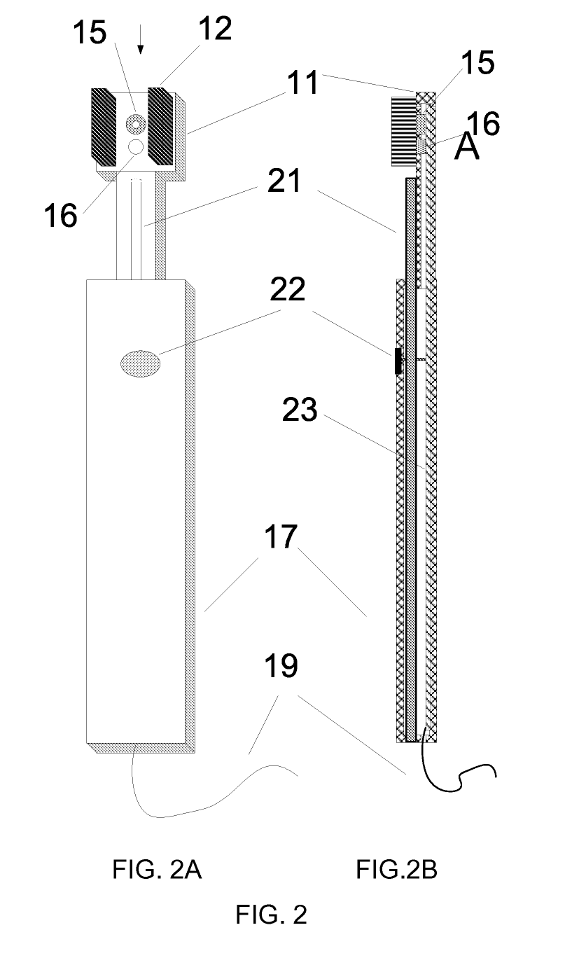

FIGS. 2A and 2B illustrate an exemplary tooth cleaning device with an image sensor 15, in accordance with an embodiment of the present invention. FIG. 2A is a front perspective view, and FIG. 2B is a cross sectional view. In the present embodiment, the tooth cleaning means and supporting means is a toothbrush with a handle 17, a head 11 and bristles 12. The toothbrush also comprises image sensor 15 and a light source 16 to capture images. These images are transmitted through a cable 19 to a display unit (not shown). In the present embodiment, a nozzle 21 is used as a means for enabling cleaning of image sensor 15 by spraying a liquid or blowing air onto it. Nozzle 21 may also spray liquid onto the teeth to aid in cleaning the teeth. Nozzle 21 connects to a pressured liquid or air source, which may be external or internal, and a switch or a button can be provided on handle 17 to switch the liquid flow through nozzle 21 on and off, for example, without limitation, a button 22. Button 22 may also operate as a means for enabling various other functions of the system such as, but not limited to, turning the system on and off, turning the imaging function and display unit 18 on and off, zooming in and out on display unit 18 to get a better view, controlling powered bristles, etc. More than one button may be needed for some implementations depending on the type and number of functions included. Button 22 may be on display unit 18, even as a touch sensing button on the screen of display 18. An electronic circuit board 23 is included for performing functions such as, but not limited to, transferring or converting image signals from image sensor 15, signal processing, sensing the operation of button 22, and controlling the entire system. The electronic components including, but not limited to, image sensor 15, light 16, button 22, and cable 19 can be attached or connected to circuit board 23.

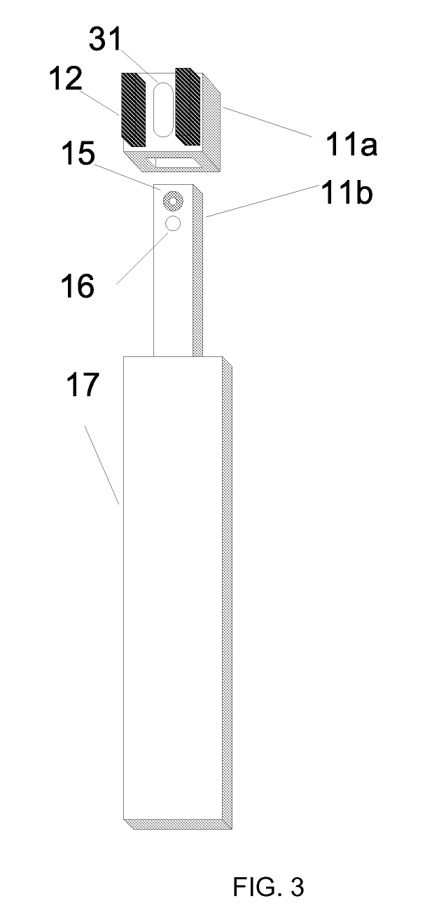

FIG. 3 is a front perspective view of an exemplary tooth cleaning device with an image sensor 15 and replaceable bristles 12, in accordance with an embodiment of the present invention. In the present embodiment, the head comprises a fixed portion 11b connected to a handle 17 and a removable cap 11a to hold bristles 12. Physically, head fixed portion 11b and handle 17 can be the two portions of an elongated object. In this case, they are still mentioned as two parts conceptually for easier discussions. Image Sensor 15 is located on fixed portion 11b. A window 31 is provided in cap 11a to generally avoid covering image sensor 15 when removable cap 11a is placed on fixed portion 11b. Window 31 can be an open hole or may be made of transparent materials. In alternate embodiments, the entire removable cap can be made of transparent materials. In other alternate embodiments, the image sensor may be located so that it is not under the cap. In these embodiments there is no need to have a window. In the present embodiment, removable cap 11a enables bristles 12 to be changed when needed. Removable cap 11a may be locked onto fixed portion 11b of head 11 using various different means such as, but not limited to, clips, sliding tracks, by screwing on, etc. In alternate embodiments multiple removable caps may be included to provide exchangeable accessories such as, but not limited to, different bristle heads for multiple users of the system, caps with flossing devices, caps with picks, etc. These embodiments enable one system to be used for multiple cleaning activities.

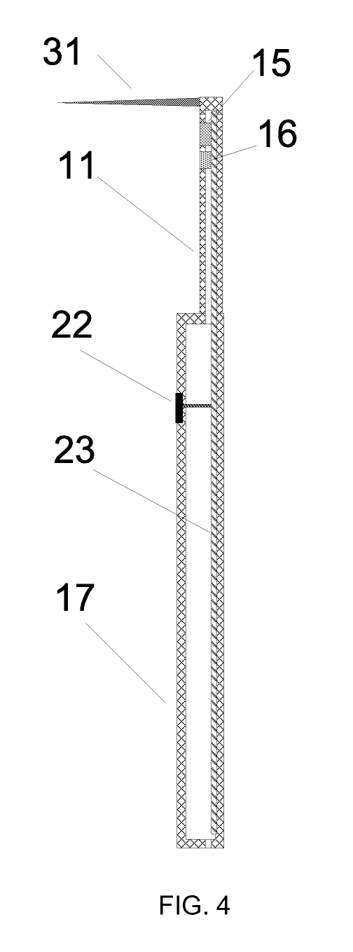

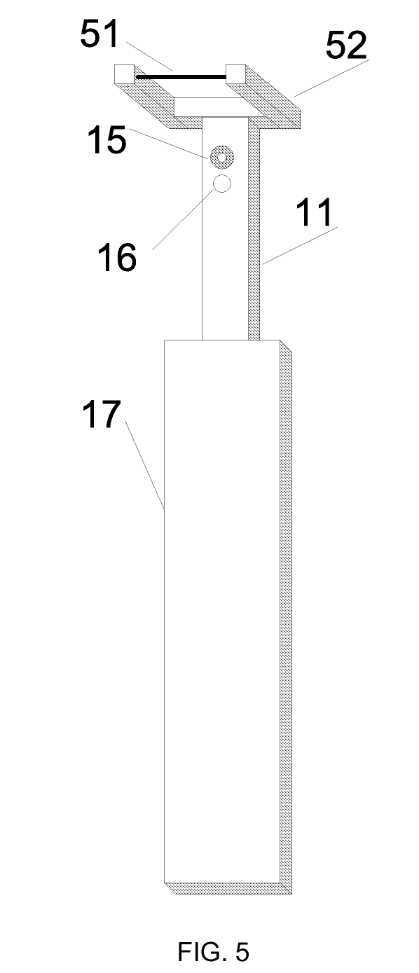

Those skilled in the art, in light of the present teachings, will readily recognize that various different designs may be used for cleaning devices in alternate embodiments. For example, without limitation, the bristles in alternate embodiments may have different configurations such as, but not limited to, a circular configuration around the image sensor, a triangular configuration, horizontal rows rather than vertical rows, etc. In other alternate embodiments, cleaning means other than bristles can be used in addition to or instead of the bristles such as, but not limited to, ultrasonic means, injected liquid, small tips or small clips, pointed tools, floss, etc. The shape of head 11, shown by way of example in FIGS. 1, 2A and 2B, is for illustration purpose. In alternate embodiments, the head can be designed in various different shapes such as, but not limited to, round shapes, triangular shapes, shapes used for special cases, such as, but not limited to, shapes suitable to clean gaps of teeth or around missing teeth, etc. Non-limiting examples of embodiments without bristles are shown by way of example in FIGS. 4 and 5.

FIG. 4 is a cross sectional view of an exemplary tooth cleaning device with an image sensor 15, in accordance with an embodiment of the present invention. In the present embodiment, the cleaning device is a dental tool with a sharp tip 31. Sharp tip 31 is located at the end of a head 11 near image sensor 15 and a light source 16, which are connected to an electronic circuit board 23 in a handle 17. A button 22, also attached to circuit board 23, enables a user to operate various functions of the cleaning system such as, but not limited to, turning image sensor 15 on or off.

FIG. 5 is a front perspective view of an exemplary tooth cleaning device with an image sensor 15, in accordance with an embodiment of the present invention. In the present embodiment, the cleaning device is a tool with dental floss 51. Dental floss 51 is held by a U-shaped member 52 at the top of a head 11 near image sensor 15 and a light source 16. A handle 17 extends from head 11.

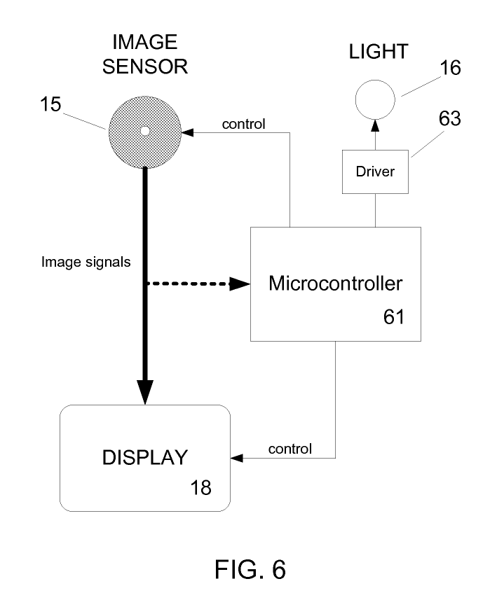

Those skilled in the art, in light of the present teachings, will readily recognize that a multiplicity of suitable means may be used in tooth cleaning systems according to various embodiments of the present invention to send the images collected by the image sensor to the display unit. Non-limiting examples of such means are illustrated by way of example in FIGS. 6 through 9. FIG. 6 is a schematic diagram of an exemplary electronic system for a tooth cleaning system in which an image sensor 15 directly sends image signals to a display unit 18, in accordance with an embodiment of the present invention. Generally, a microcontroller 61 is formed of a CPU, RAM, ROM, timer/counter, Input/Output ports, and also may include some industry standard interfaces such as USB, SPI, and I2C, and some peripherals such as display controller, image sensor interface, motor controller, memory controller, and etc. . . . Microcontroller 61 needs firmware program running inside to be functional. In the present embodiment, microcontroller 61 controls image sensor 15, display unit 18 by doing initializations, turning them on and off, and etc. Microcontroller 61 also controls light source 16 through a driver 63 by turning it on and off, or dimming it. In the case that light source 16 is LED, driver 63 normally is a constant electric current control device to provide a high and accurate enough electric current to flow through LED, and to let LED emit bright and stable enough lighting. Display unit 18 displays the image signal received from image sensor 15. Microcontrollers have wide range of performances, varying from having small and simple 4-bit processors to complex 32- or 64-bit processors, and speed from a few MHz to a few hundred MHz. The system architecture, functions, and cost consideration will decide which kind of microcontroller will be used in an implementation. In present embodiment, microcontroller 61 normally can be a simple one with 8-bit and low-speed for simple control purpose. However, when image sensor 15 outputs digital image signals, there is another option that image data also input into microcontroller 61 (shown as a dot line in FIG. 6), then the image data can be processed or stored. In this case, microcontroller may need high performance to process image data and more hardware peripherals to easily interface to image sensor 15 and support storage media. The storage media can be on-board flash memory chips, and also can be some stand-along removable storage devices such as USB memory sticks or SD memory cards. In FIG. 6 to FIG. 9, all microcontrollers can be the same or can be different, and the selection mostly depends on the functions required and cost considerations. What are not shown in FIG. 6 to FIG. 9 are the control drivers for tooth cleaning elements, for example a motor control and driver for bristle 12 in FIG. 1 when it is power-driven.

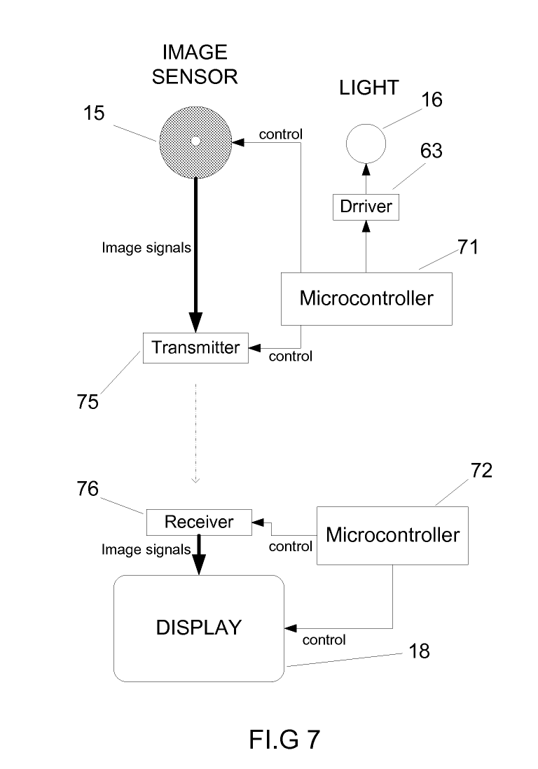

FIG. 7 is a schematic diagram illustrating an exemplary electronic system for a tooth cleaning system in which an image sensor 15 sends image signals to a display unit 18 wirelessly, in accordance with an embodiment of the present invention. Basically, present embodiment is the same as that shown in FIG. 6, except that a pair of transmitter/receiver is inserted into the image data signal transmission path to make the connection wirelessly without a cable between display unit 18 and tooth cleaning tool which has image sensor 15 on it. The other component requirements and description would be the same as what for FIG. 6. In the present embodiment, a microcontroller 71 controls image sensor 15, a transmitter 75 and a driver 63, which controls a light source 16. A microcontroller 72 controls display unit 18 and a receiver 76. Image sensor 15 sends image signals to transmitter 75. Transmitter 75 then wirelessly transmits the image signals to receiver 76, and receiver 76 sends the image signals to display unit 18, which displays these signals as images. The image signals can be digital or analog. Display unit 18 may be handheld, wall-mounted, placed on a flat surface, etc., and the wireless connection between the cleaning device and the display unit provides more flexibility in where the display unit may be located.

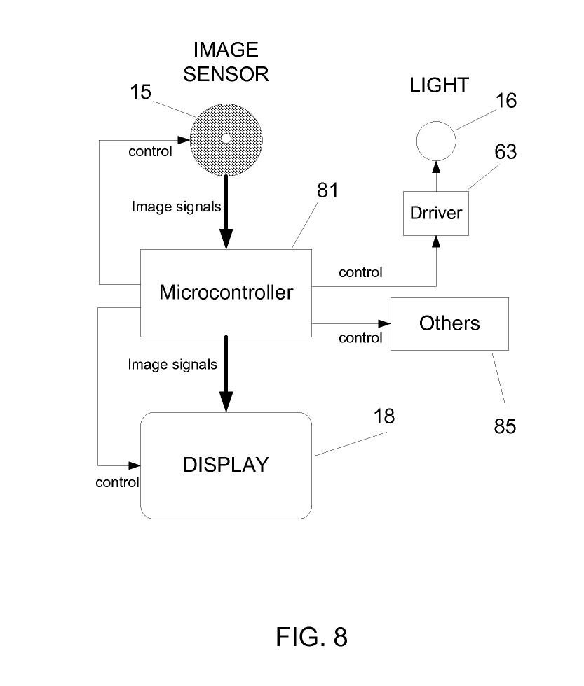

FIG. 8 is a schematic diagram illustrating an exemplary electronic system for a tooth cleaning system in which an image sensor 15 sends image signals to a microcontroller 81 and microcontroller 81 sends the image signals to a display unit 18, in accordance with an embodiment of the present invention. In the present embodiment, microcontroller 81 can process the image signals and data including, but not limited to, pattern recognition to detect earlier problems with the teeth and to provide alerts, and still picture compression to some data formats such as JPEG, or video data compression such as MPEG. Microcontroller 81 also controls other elements 85 and a driver 63, which controls a light source 16. Other elements 85 may include, without limitation, user interface elements, such as touch screen or switch buttons, or power driver for tooth cleaning element, or some status indications, or network connections.

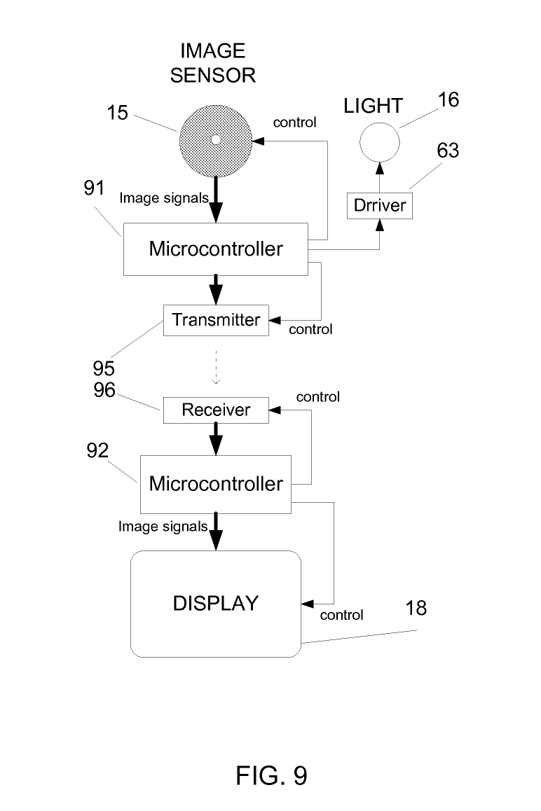

FIG. 9 is a schematic diagram illustrating an exemplary electronic system for a tooth cleaning system in which an image sensor 15 sends image signals to a microcontroller 91 and microcontroller 91 sends the image signals out from a transmitter 95 as wireless signals, in accordance with an embodiment of the present invention. If necessary, microcontroller 91 can compress the image signal data to lower the data rate for transmission and storage. In the present embodiment, transmitter 95 sends the image signals to a display unit 18 with a receiver 96, which can receive the data and display it as images. Display unit 18 may be handheld, wall-mounted, placed on a flat surface, etc. In the present embodiment, microcontroller 91 also controls a driver 63 that controls a light source 16. In some embodiments, a PC can also receive the image data and process, display, and store the data. This enables users or others to monitor the teeth and cleaning behavior over time. For example, without limitation, parents may monitor their children's teeth or a dentist may monitor his patients' teeth. Basically, present embodiment is the same as that shown in FIG. 8, except that a pair of transmitter/receiver is inserted into the image data signal transmission path to make the connection wirelessly without a cable between display unit 18 and tooth cleaning tool which has image sensor 15 on it. The other component requirements and description would be the same as what for FIG. 8. In present embodiment, digital image output from sensor 5 is preferred, and data compression and decompression may be needed before transmitted and after received.

Alternate embodiments of the present invention may be implemented for various different types of personal care activities. For example, without limitation, one alternate embodiment may provide a visual nose cleaning tool that comprises an image sensor head and a small haircutting tool. Another alternate embodiment may provide an ear cleaning tool comprising an image sensor and small tweezers. Yet another alternate embodiment may provide a self hair cutting system comprising an image sensor and a hair cutting tool. This embodiment enables a user to see the back of his head without a mirror and more effectively than when using a mirror. Those skilled in the art, in light of the present teachings, will readily recognize that a multiplicity of suitable uses may be found for other alternate embodiments of the present invention such as, but not limited to, shaving, nail trimming, cleaning the back, applying lotion or sunscreen, etc.

Having fully described at least one embodiment of the present invention, other equivalent or alternative methods of providing a cleaning system with an image sensor according to the present invention will be apparent to those skilled in the art. The invention has been described above by way of illustration, and the specific embodiments disclosed are not intended to limit the invention to the particular forms disclosed. For example, the particular implementation of the cleaning device may vary depending upon the particular type of item being cleaned. The cleaning devices described in the foregoing were directed to tooth cleaning and personal care implementations; however, similar techniques are to provide cleaning systems for cleaning other types of items such as, but not limited to, appliances, vehicles, bathroom and kitchen fixtures, etc. These embodiments enable a user to view tight, hard to reach places on a display unit while cleaning these places. Implementations of the present invention meant for non-personal use are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
means for cleaning within an oral cavity; and
means for capturing images within the oral cavity to assist a user in the cleaning.

2. The apparatus as recited in claim 1, further comprising means for illuminating objects to assist said capturing means in capturing the images.

3. The apparatus as recited in claim 1, further comprising means for enabling cleaning of an exterior surface of said capturing means.

4. The apparatus as recited in claim 1, further comprising means for supporting said cleaning means and for enabling said cleaning means to be manipulated within the oral cavity.

5. The apparatus as recited in claim 1, further comprising means for enabling one or more functions of the apparatus.

6. An apparatus comprising:
a head configured for cleaning activities within an oral cavity;
a handle for supporting said head and for enabling said head to be manipulated within the oral cavity; and
an image sensor, at least partially disposed on said head, for capturing images within the oral cavity to assist a user in the cleaning activities.

7. The apparatus as recited in claim 6, further comprising an illumination source for illuminating objects to assist said image sensor in capturing the images.

8. The apparatus as recited in claim 6, further comprising a nozzle for enabling cleaning of an exterior surface of said image sensor.

9. The apparatus as recited in claim 6, further comprising a transmitter for conveying the images to a display.

10. The apparatus as recited in claim 6, further comprising at least one control button for enabling one or more functions of the apparatus.

11. The apparatus as recited in claim 8, wherein said nozzle directs a liquid flow.

12. The apparatus as recited in claim 6, wherein said head further comprises a cap comprising a tool for the cleaning activities.

13. The apparatus as recited in claim 12, wherein said cap is removable from the remainder of said head.

14. The apparatus as recited in claim 12, wherein said tool comprises one or more brushes.

15. The apparatus as recited in claim 9, wherein said transmitter conveys said images wirelessly.

16. The apparatus as recited in claim 7, wherein said illumination source comprises a LED.

17. The apparatus as recited in claim 8, wherein said exterior surface of said image sensor comprises a lens.

18. A system comprising:
a head comprising a removable cap having a tool configured for cleaning activities within a mouth;
a handle joined to said head for enabling said head to be manipulated within the mouth;
an image sensor comprising a lens, at least partially disposed on said head, for capturing images within the mouth;
an illumination source, disposed on said head, for illuminating objects to assist said image sensor in capturing the images;
a transmitter for conveying the images;
a receiver for receiving the conveyed images; and
a display, connected to the receiver, for displaying the conveyed images thereby assisting a user in the cleaning activities.

19. The system as recited in claim 18, wherein said tool comprises one or more brushes.

20. The system as recited in claim 18, wherein said transmitter conveys said images to said receiver wirelessly.
